(19) United States
(12) Patent Application Publication
(10) Pub. No.: US 2025/0138880 A1
(43) Pub. Date: May 1, 2025

(54) CASCADED SIGNAL SELECTION

(71) Applicant: Meta Platforms Technologies, LLC, Menlo Park, CA (US)

(72) Inventors: Sreyas Mohan, Sunnyvale, CA (US); Rakesh Ranjan, Mountain View, CA (US); Yilei Li, Fremont, CA (US)

(21) Appl. No.: 18/925,225

(22) Filed: Oct. 24, 2024

Related U.S. Application Data
(60) Provisional application No. 63/593,929, filed on Oct. 27, 2023.

(51) Int. Cl. G06F 9/48; G06F 11/30

(52) U.S. Cl. CPC G06F 9/4881; G06F 11/3089

(57) ABSTRACT

A method for signal processing includes receiving a definition associated with a task, and based on the definition, selecting a first sensor modality having a first operational cost from multiple sensor modalities each associated with respective operational costs. The method further includes capturing a first sensor signal using the first sensor modality, and making a first determination that the first sensor signal is not sufficient to perform the task. The method further includes selecting, from the sensor modalities, a second sensor modality having a second operational cost, the second operational cost being higher than the first operational cost and capturing a second sensor signal using the second sensor modality. The method further includes making a second determination that the second sensor signal may be used to perform the task and using the second sensor signal to perform the task.

### CROSS-REFERENCE OF RELATED APPLICATION

This application claims the benefit of U.S. Provisional Application No. 63/593,929, filed on Oct. 27, 2023, and which is incorporated herein in its entirety.

### TECHNICAL FIELD

The present disclosure generally relates to power management for electronic devices, and more particularly to input or sensory processing on mixed-reality devices.

### BACKGROUND

Augmented reality (AR) devices, due to their small form factor, have limited power and computational resources. One of the main use cases for MR devices is to provide an always-on assistant that could provide the user with useful information or functionality when needed. As such, an MR device is expected to be constantly processing input signals to determine the needs of the user. Sensory signal processing, however, consumes a lot of energy and could quickly drain the MR device of its limited energy store, especially when operating constantly.

As such, there is a need for improving power efficiency of augmented reality devices.

### SUMMARY

Some embodiments of the present disclosure provide a method for cascaded signal selection and processing. The method includes receiving a definition associated with a task, and based on the definition, selecting, from multiple sensor modalities each associated with respective operational costs, a first sensor modality having a first operational cost. Responsive to selecting the first sensor modality, the method further includes capturing a first sensor signal using the first sensor modality, and based on the first sensor signal, making a first determination that the first sensor signal is not sufficient to perform the task. Based on the definition and the first determination, the method further includes selecting, from the multiple sensor modalities, a second sensor modality having a second operational cost, the second operational cost being higher than the first operational cost. Responsive to selecting the second sensor modality, the method further includes capturing a second sensor signal using the second sensor modality, and based on the second sensor signal, making a second determination that the second sensor signal may be used to perform the task. Responsive to the second determination, the method further includes using the second sensor signal to perform the task.

Some embodiments of the present disclosure provide a non-transitory non-volatile computer-readable medium storing a program for cascaded signal selection and processing. The program, when executed by a computer, configures the computer to receive a definition associated with a task, and based on the definition, select from multiple sensor modalities each associated with respective operational costs, a first sensor modality having a first operational cost. Responsive to selecting the first sensor modality, the executed program further configures the computer to capture a first sensor signal using the first sensor modality, and based on the first sensor signal, make a first determination that the first sensor signal is not sufficient to perform the task. Based on the definition and the first determination, the executed program further configures the computer to select, from the multiple sensor modalities, a second sensor modality having a second operational cost, the second operational cost being higher than the first operational cost. Responsive to selecting the second sensor modality, the executed program further configures the computer to capture a second sensor signal using the second sensor modality, and based on the second sensor signal, make a second determination that the second sensor signal may be used to perform the task. Responsive to the second determination, the executed program further configures the computer to use the second sensor signal to perform the task.

Some embodiments of the present disclosure provide a system for cascaded signal selection and processing. The system comprises a processor and a non-transitory non-volatile computer readable medium storing a set of instructions, which when executed by the processor, configure the processor to receive a definition associated with a task, and based on the definition, select from multiple sensor modalities each associated with respective operational costs, a first sensor modality having a first operational cost. Responsive to selecting the first sensor modality, the executed instructions further configure the system to capture a first sensor signal using the first sensor modality, and based on the first sensor signal, make a first determination that the first sensor signal is not sufficient to perform the task. Based on the definition and the first determination, the executed instructions further configure the system to select, from the multiple sensor modalities, a second sensor modality having a second operational cost, the second operational cost being higher than the first operational cost. Responsive to selecting the second sensor modality, the executed instructions further configure the system to capture a second sensor signal using the second sensor modality, and based on the second sensor signal, make a second determination that the second sensor signal may be used to perform the task. Responsive to the second determination, the executed instructions further configure the system to use the second sensor signal to perform the task.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement cascading signal selection, according to some embodiments.

FIG. 2 is a block diagram illustrating details of a system for cascading signal selection, according to some embodiments.

FIG. 3A illustrates a virtual/mixed reality head-mounted display, according to some embodiments.

FIG. 3B illustrates a system which includes a mixed reality HMD and a core processing component, according to some embodiments.

FIG. 3C illustrates controllers that a user can hold in one or both hands to interact with an artificial reality environment presented by the HMDs of FIGS. 3A and 3B, according to some embodiments.

FIG. 4 is a flowchart illustrating a process for a cascading signal selection, according to some embodiments.

FIG. 5 is a flowchart illustrating a process for signal processing, according to some embodiments.

FIG. 6 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an MR headset could be shaped as a pair of glasses with a pass-through display, which allows light from the real-world to pass through a waveguide that simultaneously emits light from a projector in the MR headset, allowing the MR headset to present virtual objects intermixed with the real objects the user can see. As another example, an MR headset may be a light-blocking headset with an internal screen and optional video pass-through from external cameras. “Mixed reality” or “MR,” as used herein, refers to any of VR, AR, XR, or any combination or hybrid thereof.

Techniques described herein provide a cascading system for processing signals of different modalities. A mixed-reality device may have a variety of sensors, including motion sensors (e.g. inertial measurement units (IMUs), accelerometers, gyroscopes, etc.), audio sensors, depth sensors, image sensors, etc. These sensors enable MR devices to perceive the world and understand the context surrounding the user. Different types of sensors may capture different signal modalities. For example, motion sensors may capture motion signals (e.g., user walking, turning, tapping, etc.), audio sensors may capture speech commands or environmental sounds, and depth and/or image sensors may capture gestures or visible features of the environment. Using an input modality involves some or all of instructing the corresponding sensor to perform a sensor capture, storing the signal from the sensor as data to memory, reading the captured data from memory, processing the data, and outputting the data. These operations all consume energy. Different input modalities have different associated operational costs. The exact cost depends on the hardware and software architecture and the particular use case. In general, energy consumption for using motion/IMU data is relatively lower than using image data (e.g., for performing computer vision tasks), and energy consumption for using audio data falls somewhere in between.

An MR device may use a variety of perception modules designed to process and/or understand sensor signals captured by its sensors. Some modules may only use a single signal modality (e.g., image data only), while others may use multiple (e.g., a combination of video, image, audio, IMU data, and the like). Generally, using more types of signal modalities allow perception modules to understand the user's environment or context better, since the different signal types provides richer information. However, given the energy costs associated with using each type of signal modality, using all available modalities all the time would be inefficient and cost-prohibitive for resource-constrained devices like MR headsets.

Embodiments described herein address the above-identified problems by providing a cascading approach for selectively using modality signals. For each system or application, a hierarchy or ranking of the operational costs associated with each available modality signal may be determined. For example, in some embodiments, IMU data may be considered as low cost, audio data may be considered as medium cost, and image data may be considered as high cost. Under the cascading approach described herein, an MR device may use a selection module (e.g., a machine-learning model) to progressively process tiers of modality signals to determine which tier(s) would likely be sufficient for a given task. For example, the selection module may first process the captured IMU data to determine if it alone would be sufficient to determine a state or context of the user. If it is sufficient, the selection module may then trigger an application module (e.g., a mixed-reality application, or any other application executing on the MR device) to process the selected modality signal. In some embodiments, the selection module may include a machine-learning model for determining the current user context or user command based on the selected signal modalities. As an example, if IMU alone is insufficient, the selection module may process the next costly modality signal, such as audio, or a combination of the next costly modality signal and the previously-considered lower-cost modality signal (e.g., a combination of audio and IMU), to determine whether the combination would be sufficient for the application module to reach a reasonably confident conclusion/inference. In other words, the selection module would determine if the additional modality signal (e.g., audio in this example) would likely provide sufficient information for the application module to perform its task. This cascading selection process may repeat until the selection module settles on a particular tier or combination of tiers of modality signals. Using this cascading selection process allows the MR device to use the least number of modalities to accomplish the task at hand.

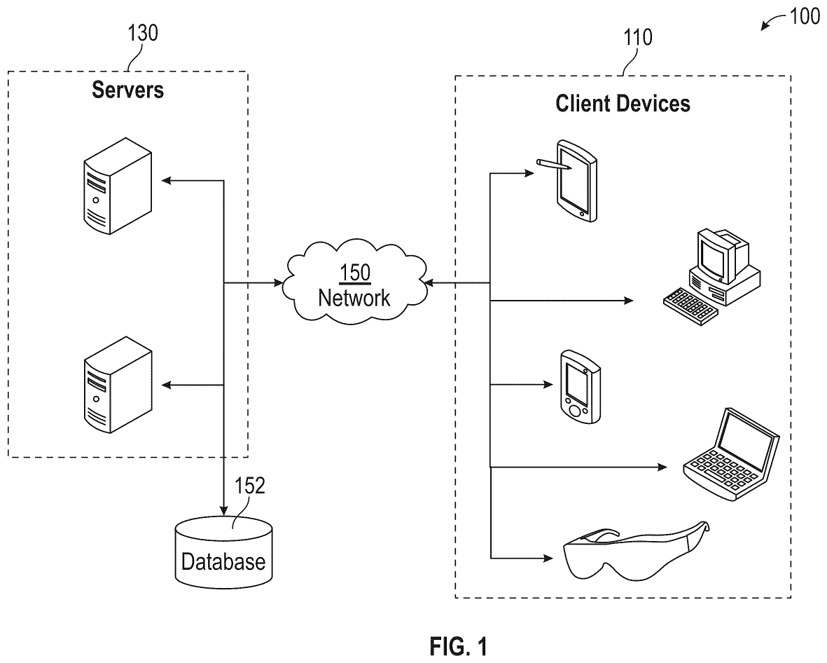

FIG. 1 illustrates a network architecture 100 used to implement cascading signal selection, according to some embodiments. The network architecture 100 may include one or more client devices 110 and servers 130, communicatively coupled via a network 150 with each other and to at least one database, e.g. database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

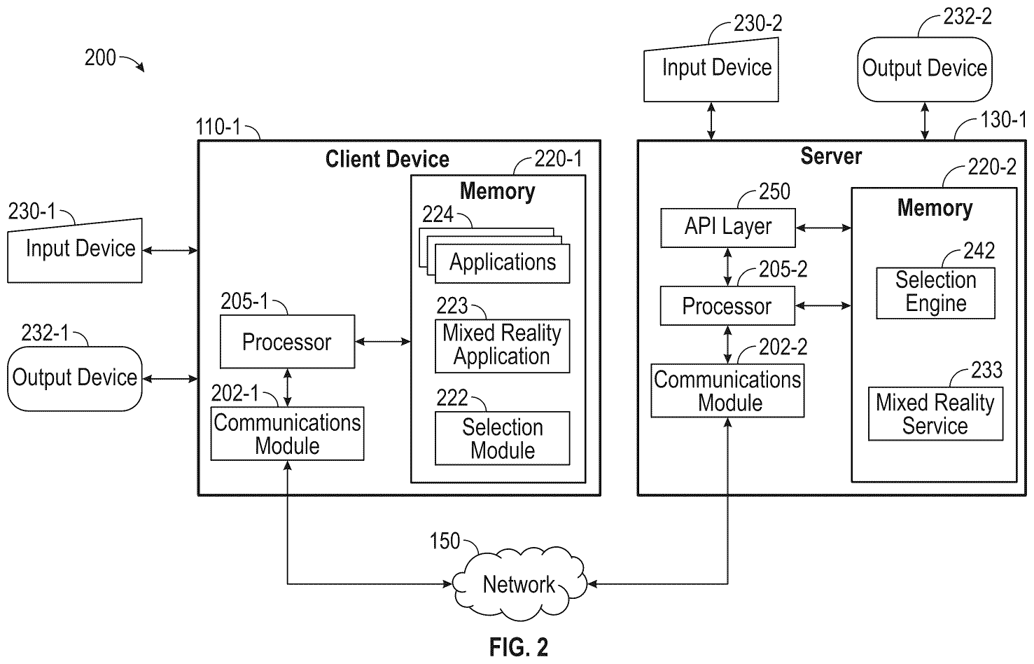

FIG. 2 is a block diagram illustrating details of a system 200 for cascading signal selection, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like.

In some embodiments, input devices 230 may include various sensors, including but not limited to touch sensors, acoustic sensors (e.g., microphones), image and/or video sensors (e.g., cameras), inertial motion units, and the like. In some embodiments, communications modules 202 may include at least one perception component designed to process and/or understand signals captured by sensors, and provide the captured signals to the processors 205, and to modules, engines, services, applications, and the like executing or operating in memories 220.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232. In some embodiments, the processor 205-1 is configured to control a graphical user interface (GUI) (e.g., spanning at least a portion of input devices 230 and output devices 232) for the user of client device 110-1 to access the server 130-1.

Memory 220-1 may further include a selection module 222, configured to execute on client device 110-1 and couple with input device 230-1 and output device 232-1. The selection module 222 may include specific instructions which, when executed by processor 205-1, cause operations to be performed consistent with embodiments of the present disclosure. In some embodiments, the selection module 222 runs on an operating system (OS) installed in client device 110-1.

Memory 220-1 may further include a mixed reality application 223, configured to execute in client device 110-1. The mixed reality application 223 may be downloaded by the user from server 130-1, and/or may be hosted by server 130-1. The selection module 222 may communicate directly with the mixed reality application 223 and/or indirectly with the mixed reality application 223 (e.g., via the OS of the client device 110-1). Memory 220-1 may further include other applications 224 (not shown in FIG. 2) configured to execute in client device 110-1, including but not limited to a personal assistant application, a game application, a navigation application, a communications application, a phone application, a social media application, a video application, an image application, and the like.

The mixed reality application 223 may communicate with a mixed reality service 233 in memory 220-2 of the server 130-1 to provide a mixed reality environment or experience to a user of client device 110-1. The mixed reality service 233 may share or provide features and resources with the client device 110-1, including data, libraries, and/or applications (e.g., mixed reality application 223). The user may access the mixed reality service 233 through the mixed reality application 223. The mixed reality application 223 may be installed in client device 110-1 by the mixed reality service 233 and/or may execute scripts, routines, programs, applications, and the like provided by the mixed reality service 233.

In some embodiments, memory 220-2 includes a selection engine 242. The selection engine 242 may be configured to perform methods and operations consistent with embodiments of the present disclosure. The selection engine 242 may share or provide features and resources with the client device 110-1, including data, libraries, and/or applications retrieved with selection engine 242 (e.g., selection module 222). The user may access the selection engine 242 through the selection module 222. The selection module 222 may be installed in client device 110-1 by the selection engine 242 and/or may execute scripts, routines, programs, applications, and the like provided by the selection engine 242. For example, in some embodiments, selection engine 242 may be a language model that is accessed via selection module 222 to perform cascading signal selection.

In some embodiments, server 130-1 provides an API layer 250. The mixed reality application 223 may communicate with mixed reality service 233 through the API layer 250. Furthermore, the selection module 222 may communicate with the selection engine 242 through the API layer 250.

In various embodiments, the selection module 222, the selection engine 242, or any combination thereof may be implemented in a variety of ways. For example, in some embodiments, the selection module 222 and/or the selection engine 242 may be a machine-learning model trained to process one or more types of modality signals and output a score that reflects a likelihood of the signals being sufficient for a particular application module to perform its tasks. The selection module 222 and/or the selection engine 242 may be a light-weight or small machine-learning model relative to the application module. The selection module 222 and/or the selection engine 242 may be trained using a training dataset. Each training sample may include one or more modalities of signals (including but not limited to IMU signals, audio signals, image signals, and video signals) and a ground-truth label reflecting whether the signals are deemed sufficient for a downstream application module (e.g., a mixed reality application, a personal assistant application, and the like). During training, the selection module 222 and/or the selection engine 242 may process the signals in each training sample and output a score. A comparison of the score to the ground-truth label associated with that training sample may be quantified using a loss function. The computed “loss” may then be back-propagated to update the selection module 222 and/or the selection engine 242 so that it would learn from the training sample and perform better. The training process may repeat any number of times until a terminating condition is met. For example, training may terminate after a predetermined number of training iterations have completed and/or when the “loss” stays within a certain acceptable threshold. Once trained, the selection module 222 and/or the selection engine 242 may be deployed onto end-user devices (e.g., client devices 110, servers 130, etc.). In some embodiments, the selection engine 242 is trained as described above, and the selection module 222 is a lightweight client that executes on a client device 110-1 and communicates with the selection engine 242 on a server 130-1.

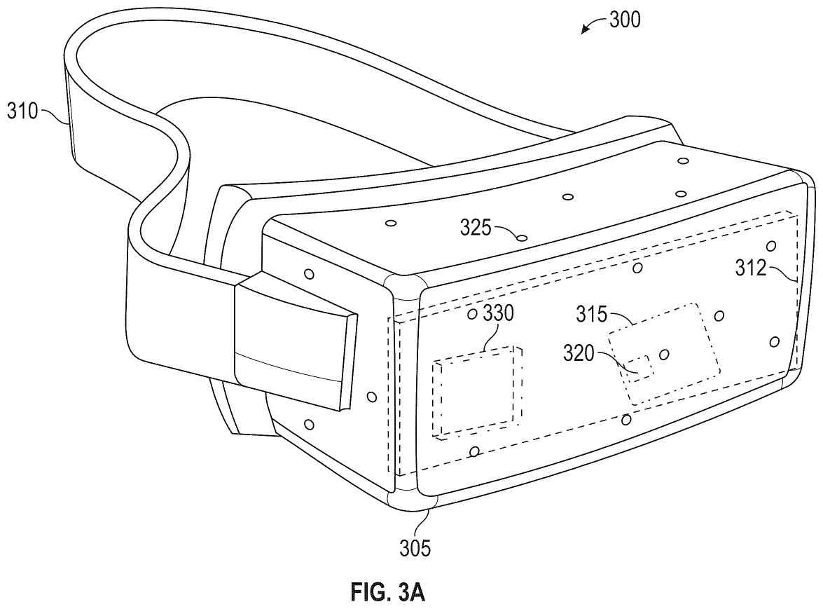

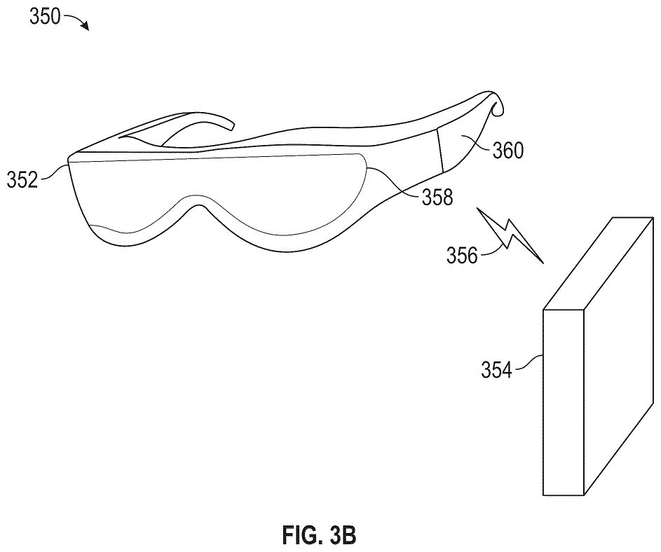

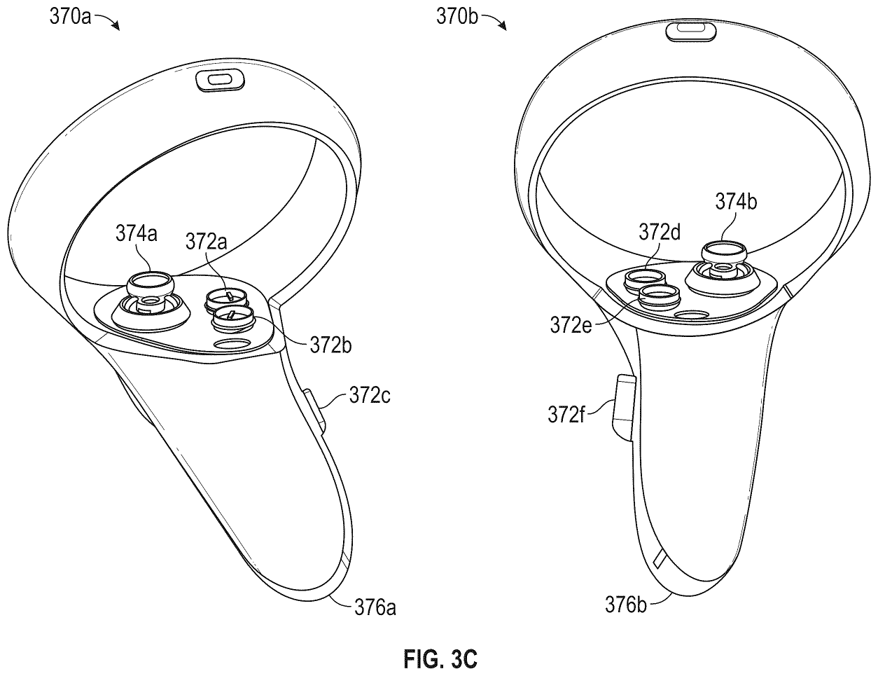

FIGS. 3A-3B are diagrams illustrating mixed reality headsets, according to certain aspects of the present disclosure. FIG. 3A is a diagram of a VR/MR HMD 300. In various embodiments, the VR/MR HMD 300 may be used, as one or more of client devices 110 (e.g., as a non-limiting example, client device 110-1) or as one or more of servers 130 (e.g., as a non-limiting example, server 130-1).

The VR/MR HMD 300 includes a front rigid body 305 and a band 310. The front rigid body 305 includes one or more electronic display elements such as an electronic display 312, an inertial motion unit (IMU) 315, one or more position sensors 320, locators 325, and one or more compute units 330. The position sensors 320, the IMU 315, and compute units 330 may be internal to the VR/MR HMD 300 and may not be visible to the user. In various implementations, the IMU 315, position sensors 320, and locators 325 may track movement and location of the VR/MR HMD 300 in the real world and in a virtual environment in three degrees of freedom (3DoF), six degrees of freedom (6DoF), etc. For example, the locators 325 may emit infrared light beams which create light points on real objects around the VR/MR HMD 300. As another example, the IMU 315 may include, e.g., one or more accelerometers, gyroscopes, magnetometers, other non-camera-based position, force, or orientation sensors, or combinations thereof. One or more cameras (not shown) integrated with the VR/MR HMD 300 may detect the light points, such as for a computer vision algorithm or module. The compute units 330 in the VR/MR HMD 300 may use the detected light points to extrapolate position and movement of the VR/MR HMD 300 as well as to identify the shape and position of the real objects surrounding the VR/MR HMD 300.

In some embodiments, the compute units 330 may include a module (e.g., as a non-limiting example, selection module 222) that monitors energy usage, battery life, and other parameters of the VR/MR HMD 300.

The electronic display 312 may be integrated with the front rigid body 305 and may provide image light to a user as dictated by the compute units 330. In various embodiments, the electronic display 312 may be a single electronic display or multiple electronic displays (e.g., a display for each user eye). Examples of the electronic display 312 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 312 may be coupled with an audio component, such as sending and receiving output from various other users of the XR environment wearing their own XR headsets, for example. The audio component may be configured to host multiple audio channels, sources, or modes.

In some implementations, the VR/MR HMD 300 may be coupled to a core processing component such as a personal computer (PC) (not shown) and/or one or more external sensors (not shown). In some embodiments, the core processing component may include a module (e.g., as a non-limiting example, selection module 222) that monitors energy usage, battery life, and other parameters of the VR/MR HMD 300.

The external sensors may monitor the VR/MR HMD 300 (e.g., via light emitted from the VR/MR HMD 300) which the PC may use, in combination with output from the IMU 315 and position sensors 320, to determine the location and movement of the VR/MR HMD 300.

FIG. 3B is a diagram of an HMD system 350 which includes an MR HMD 352 and a core processing component 354. In some embodiments, the core processing component 354 may include a module (e.g., as a non-limiting example, selection module 222) that monitors energy usage, battery life, and other parameters of the MR HMD 352. HMD system 350 may also include additional components not shown in FIG. 3B, including but not limited to input components, tracking components, and output components.

In various embodiments, components of HMD system 350 may be used, as one or more of client devices 110 (e.g., as a non-limiting example, client device 110-1) or as one or more of servers 130 (e.g., as a non-limiting example, server 130-1). For example, in some embodiments, the MR HMD 352 may be used as one or more of client devices 110 (e.g., as a non-limiting example, client device 110-1).

The MR HMD 352 and the core processing component 354 may communicate via a wireless connection (e.g., a 60 GHz link) as indicated by the link 356. In other implementations, the HMD system 350 includes a headset only, without an external compute device, or includes other wired or wireless connections between the MR HMD 352 and the core processing component 354. The MR HMD 352 includes a pass-through display 358 and a frame 360. The frame 360 may house various electronic components (not shown) such as light projectors (e.g., LASERs, LEDs, etc.), cameras, eye-tracking sensors, MEMS components, networking components, etc. The frame 360 or another part of the MR HMD 352 may include an audio electronic component such as a speaker (not shown in FIG. 3B). The speaker may output audio from various audio sources, such as a phone call, VoIP session, or other audio channel. The electronic components may be configured to implement audio switching based on user gaming or XR interactions.

The projectors may be coupled to the pass-through display 358, e.g., via optical elements, to display media to a user. The optical elements may include one or more waveguide assemblies, reflectors, lenses, mirrors, collimators, gratings, etc., for directing light from the projectors to a user's eye. Image data may be transmitted from the core processing component 354 via link 356 to MR HMD 352. Controllers in the MR HMD 352 may convert the image data into light pulses from the projectors, which may be transmitted via the optical elements as output light to the user's eye. The output light may mix with light that passes through the pass-through display 358, allowing the output light to present virtual objects that appear as if they exist in the real world.

Similarly to the VR/MR HMD 300, the HMD system 350 may also include motion and position tracking units, cameras, light sources, etc., which allow the HMD system 350 to, e.g., track itself in 3DoF or 6DoF, track portions of the user (e.g., hands, feet, head, or other body parts), map virtual objects to appear as stationary as the MR HMD 352 moves, and have virtual objects react to gestures and other real-world objects. For example, the HMD system 350 may track the motion and position of the user's wrist movements as input gestures for performing XR navigation. As an example, the HMD system 350 may include a coordinate system to track the relative positions of various XR objects and elements in a shared artificial reality environment.

FIG. 3C illustrates controllers 370a-370b, which, in some implementations, a user may hold in one or both hands to interact with an artificial reality environment presented by the VR/MR HMD 300 and/or MR HMD 352. In some embodiments, the controllers 370a-370b may be used, as one or more of client devices 110 (e.g., as a non-limiting example, client device 110-1).

The controllers 370a-370b may be in communication with an HMD (e.g., VR/MR HMD 300, MR HMD 352, and the like), either directly or via an external device (e.g., core processing component 354). The controllers 370a-370b may have some or all of their own IMU units, position sensors, processors, cameras, light emitters, and/or other sensors or components. The VR/MR HMD 300 or MR HMD 352, external sensors, or sensors in the controllers 370a-370b may be used in any combination to track controllers 370a-370b to determine the positions and/or orientations thereof (e.g., to track the controllers in 3DoF or 6DoF). As an example, the compute units 330 in the VR/MR HMD 300 or the core processing component 354 may use this tracking, either alone or in combination with IMU and/or position sensor output, to monitor hand positions and motions of the user. As another example, the compute units 330 may use the monitored hand positions to implement navigation, scrolling, and other user inputs via the hand positions and motions of the user.

The controllers 370a-370b may also include various buttons (e.g., buttons 372a-f) and/or joysticks (e.g., joysticks 374a-b), which a user may actuate to provide input and interact with objects. As discussed below, controllers 370a-370b may also have tips 376a and 376b, which, when in scribe controller mode, may be used as the tip of a writing implemented in the artificial reality environment. In various implementations, the VR/MR HMD 300 or MR HMD 352 may also include additional subsystems, such as a hand tracking unit, an eye tracking unit, an audio system, various network components, etc., to monitor indications of user interactions and intentions. For example, in some implementations, instead of or in addition to controllers, one or more cameras included in the VR/MR HMD 300 or MR HMD 352, or from external cameras, may monitor the positions and poses of the user's hands to determine gestures and other hand and body motions. Such camera-based hand tracking may be referred to as computer vision, for example. Sensing subsystems of the VR/MR HMD 300 or MR HMD 352 may be used to define motion (e.g., user hand/wrist motion) along an axis (e.g., three different axes).

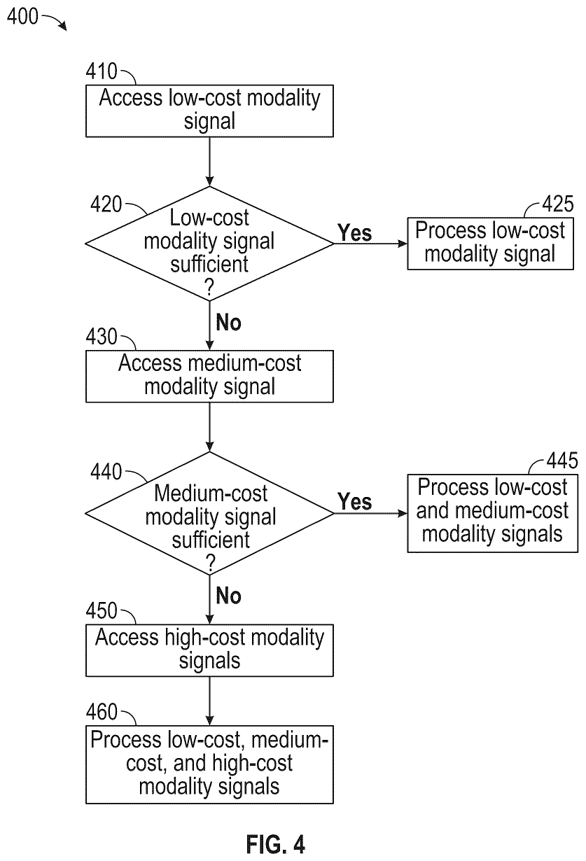

FIG. 4 is a flowchart illustrating a process 400 for a cascading signal selection performed by a client device (e.g., client device 110-1, etc.) and/or a client server (e.g., server 130-1, etc.), according to some embodiments. In some embodiments, one or more operations in process 400 may be performed by a processor circuit (e.g., processors 212, etc.) executing instructions stored in a memory circuit (e.g., memories 220, etc.) of a system (e.g., system 200, etc.) as disclosed herein. For example, some or all of operations in process 400 may be performed by selection module 222. Moreover, in some embodiments, a process consistent with this disclosure may include at least operations in process 400 performed in a different order, simultaneously, quasi-simultaneously, or overlapping in time.

The cascading modality-selection process 400 may be used in a variety of contexts, such as helping a personal assistant application determine which modality signals to use. Such a personal assistant application, described below as an example of an application module, is designed to provide users with helpful information or functionality depending on the current context. The personal assistant application is used only as a non-limiting example below; other applications (e.g., mixed reality application 223, applications 224, and the like) may also benefit from the techniques described herein.

At 410, the process 400 accesses a low-cost modality signal. In some embodiments, the process 400 selects the low-cost modality signal from a group of multiple available signals. The selection may include a determination that the selected signal is a low-cost signal. The selection may further include a determination that the selected signal is relevant to a task to be performed by an application. The low-cost modality signal may include, but is not limited to, IMU signals.

At 420, the process 400 determines whether the low-cost modality signal provides sufficient information for the application to perform its task. To make the determination, the process 400 may perform a lookup in a database or a lookup table, based on the type of the task and the type of signal.

If the process 400 determines (at 420) that the low-cost modality signal provides sufficient information for the application to perform its task, then the process 400 continues to 425 to process the low-cost modality signal. If the process 400 determines (at 420) that the low-cost modality signal does not provide sufficient information for the application to perform its task, then the process 400 continues to 430, which is described below.

As an example, the task may be for a personal assistant application executing on a user's headset device (e.g., MR HMU 352) to help the user navigate as the user walks down a street. As such, the personal assistant application would not need to be active if the user is stationary. Thus, if a low-cost modality signal such as IMU data indicates that the user is not moving (e.g., the user is seated), a selection module executing on the headset (e.g., selection module 222) may determine that IMU data alone would be sufficient for the personal assistant application at this time, because the personal assistant program need not provide any navigation guidance while the user is stationary. The selection module may then instruct the personal assistant application to proceed with processing the IMU data. Upon processing the low-cost modality data and recognizing that the user is likely stationary, may run in low-power mode (e.g., low in a lower frequency) or turn off certain functionalities.

Continuing with the example above, if the IMU data indicates that the user is walking, the personal assistant application would need be active and ready to help the user navigate. In this case, the IMU data alone would be insufficient for the task of navigation, so the personal assistant application may need to access the next tier of modality signal, such as an audio signal. Accordingly, the personal assistant application may access audio signals captured by one or more microphones of the MR device.

At 430, the process 400 accesses a medium-cost modality signal. In some embodiments, the process 400 selects the medium-cost modality signal from a group of multiple available signals. The selection may include a determination that the selected signal is a medium-cost signal. The selection may further include a determination that the selected signal is relevant to a task to be performed by an application. The medium-cost modality signal may include, but is not limited to, audio signals.

At 440, the process 400 determines whether the medium-cost modality signal provides sufficient information for the application to perform its task. The process 400 may also determine whether a combination of the medium-cost modality signal and the previously-accessed low-cost modality signal provides sufficient information for the application to complete the task. To make the determination, the process 400 may perform a lookup in a database or a lookup table, based on the type of the task and the type of signal.

If the process 400 determines (at 440) that the medium-cost modality signal (or a combination thereof with the low-cost modality signal) provides sufficient information for the application to perform its task, then the process 400 continues to 445 to process the low-cost and medium-cost modality signals. If the process 400 determines (at 440) that the medium-cost modality signal does not provide sufficient information for the application to perform its task (either singly, or combined with the low-cost modality signal), then the process 400 continues to 450, which is described below.

Continuing with the example above, the selection module may process the audio signal or a combination of the audio signal and the previously-accessed lower-cost signal (e.g., IMU data in this example) to determine whether the information accessed thus far would be sufficient for the personal assistant application. The IMU data may still be in memory, so no additional cost of data retrieval would be needed. The selection module, using the retrieved signals and/or additional information such as the current application state or user context, may determine that the combination of audio and/or IMU signals would provide sufficient information for the personal assistant application at this time. For example, when the user is walking, the personal assistant application may be configured to be in a standby state, awaiting instructions from the user. Until the personal assistant application receives a command from the user that navigational guidance is needed, the personal assistant application would only need to listen for or process the user's spoken instructions and does not yet need image data to perform computer-vision-based navigation assistance. Concluding that the audio and/or IMU signals are sufficient, the selection module may instruct the personal assistant application to only use those modality signals. Accordingly, the personal assistant application may process the audio and/or IMU signals to determine whether the user has provided instructions (e.g., the personal assistant application may include a speech recognition module).

In another scenario, the selection module may instead determine that the audio and/or IMU signals are insufficient for the personal assistant application. Such a determination may result because the user is walking, and the personal assistant application has already received instructions from the user that navigation assistance is needed. The selection module may instruct the personal assistant application to use high-cost modality signals, such as image signals, to accomplish its task. Accordingly, the personal assistant application may access image signals captured by one or more cameras of the MR device.

At 450, the process 400 accesses a high-cost modality signal. In some embodiments, the process 400 selects the high-cost modality signal from a group of multiple available signals. The selection may include a determination that the selected signal is a high-cost signal. The selection may further include a determination that the selected signal is relevant to a task to be performed by an application. The high-cost modality signal may include, but is not limited to, image or video signals.

At 460, the process 400 processes the high-cost modality signal, and optionally processes the low-cost and medium-cost modality signals. In some circumstances, the high-cost modality signal may be sufficient information for the application to perform its task or may be combined with one or more of the low-cost modality signal and the medium-cost modality signal, depending on the task and the application.

Continuing with the example above, the personal assistant application may process the image signal and one or more of the previously obtained lower-cost modality signals (e.g., audio and/or IMU) to perform its task. For example, the personal assistant application may process image, audio, and IMU data to determine that the user is walking down a street and looking for a café. Based on such determination, the personal assistant application may display nearby cafés and provide directions or recommendations. As demonstrated via this example, the personal assistant application only uses the minimum signals needed to perform its intended tasks, thereby operating more efficiently by avoiding unnecessary energy expenditure.

The discussion with respect to FIG. 4, and the example above, illustrate scenarios in which there are three signals (low, medium, and high cost) to select from. In some embodiments, the process 400 may make fewer or further determinations as needed, to utilize as many or as few modality signals as may be required for the task to be performed by the application.

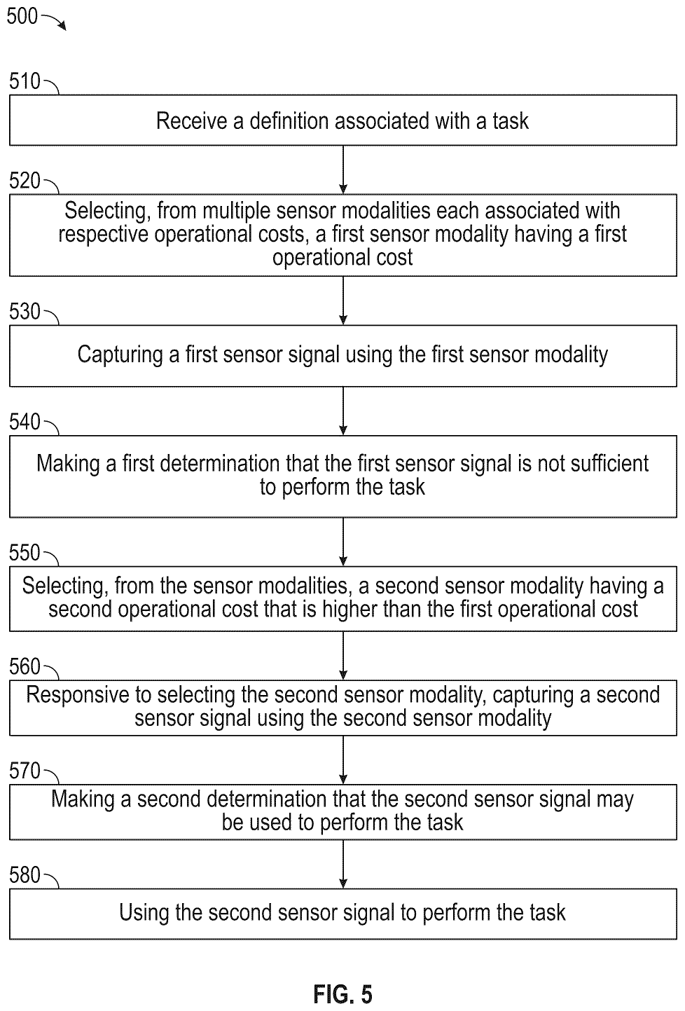

FIG. 5 is a flowchart illustrating a process 500 for signal processing performed by a client device (e.g., client device 110-1, etc.) and/or a client server (e.g., server 130, etc.), according to some embodiments. In some embodiments, one or more operations in process 500 may be performed by a processor circuit (e.g., processors 212, etc.) executing instructions stored in a memory circuit (e.g., memories 220, etc.) of a system (e.g., system 200, etc.) as disclosed herein. For example, operations in process 500 may be performed by selection module 222, selection engine 242, applications 224, or some combination thereof. Moreover, in some embodiments, a process consistent with this disclosure may include at least operations in process 500 performed in a different order, simultaneously, quasi-simultaneously, or overlapping in time.

At 510, the process 500 receives a definition associated with a task. The task may be associated with an application executing on a client device (e.g., client device 130-1). For example, in some embodiments, the task may be a personal assistant application, a mixed-reality application (e.g., mixed reality application 223), or another type of application (e.g., applications 224) executing on a mixed-reality headset (e.g., VR/MR HMD 300 or MR HMD 352). The definition may include parameters and information about the task and the application, including but not limited to processing, energy, and/or data input requirements to execute the task.

At 520, the process 500 selects, from multiple sensor modalities each associated with respective operational costs, a first sensor modality having a first operational cost. The selection at 520 may be based on the task definition. The sensor modalities may include, but are not limited to, an inertial measurement unit (IMU) modality, an audio modality, an image modality, and a video modality.

Each operational cost may include one or more of an energy usage cost, an energy efficiency cost, or a computational cost. In some embodiments, the sensor modalities may be ordered according to their respective operational costs, and selecting the first sensor modality is equivalent to selecting a signal modality with a lowest operational cost.

At 530, the process 500 captures a first sensor signal using the first sensor modality that was selected at 520.

At 540, the process 500 makes a first determination that the first sensor signal is not sufficient to perform the task. The determination may be based on processing and analysis of the first sensor signal. Based on the first determination, the first sensor signal may be stored in a temporary data storage or cache of the client device.

At 550, the process 500 selects, from the plurality of sensor modalities, a second sensor modality having a second operational cost that is higher than the first operational cost. The selection at 550 may be based on the definition and the first determination.

At 560, the process 500 captures a second sensor signal using the second sensor modality that was selected at 550.

At 570, the process 500 makes a second determination that the second sensor signal may be used to perform the task. The determination may be based on processing and analysis of the second sensor signal.

In some embodiments, the second determination includes a determination determining that the second sensor signal may be used to perform the task when combined with the first sensor signal. In other words, the first sensor signal alone is insufficient to perform the task, the second sensor signal alone is insufficient to perform the task, but a combination of the first sensor signal and the second sensor signal is sufficient to perform the task.

In some embodiments, the second determination includes a determination that the first sensor signal is not necessary to perform the task while the second sensor signal is available. In other words, the second sensor signal alone is sufficient to perform the task.

At 580, the process 500 uses the second sensor signal to perform the task.

In embodiments where the second determination included determining that the second sensor signal alone is insufficient to perform the task, then the process 500 at 580 uses the first sensor signal in addition to the second sensor signal to perform the task. The process 500 may retrieve the first sensor signal from the temporary storage or cache. In embodiments where the second determination included determining that the second sensor signal alone is sufficient to perform the task, the process 500 may discard the first sensor signal from the temporary storage or cache.

In some embodiments, the process 500 may determine that the second sensor signal is insufficient, either alone or in combination with the first sensor signal, to perform the task. The process 500 may continue by selecting, from the plurality of sensor modalities, a third sensor modality having a third operational cost, wherein the third operational cost is higher than the first and second operational costs and capturing a third sensor signal using the third sensor modality. In this manner, process 500 may recursively continue until sufficient sensor signals (or combinations thereof) of progressively higher operational costs have been captured so that the task may be performed. By using a cascading approach, the process 500 may perform the task with minimum operational cost.

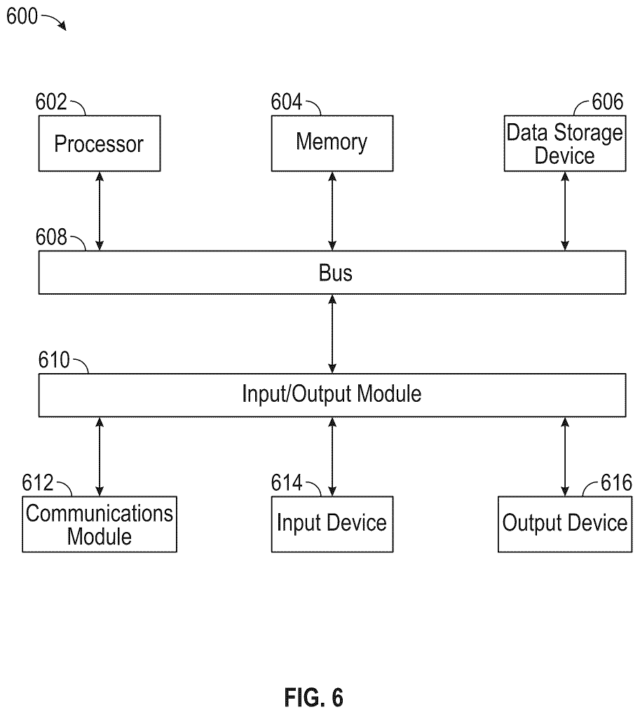

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities. As a non-limiting example, the computer system 600 may be one or more of the servers 130 and/or the client devices 110.

Computer system 600 includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described embodiments can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads application data and provides an application, information may be read from the application data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for signal processing, comprising:
receiving a definition associated with a task;
based on the definition, selecting, from a plurality of sensor modalities each associated with respective operational costs, a first sensor modality having a first operational cost;
responsive to selecting the first sensor modality, capturing a first sensor signal using the first sensor modality;
based on the first sensor signal, making a first determination that the first sensor signal is not sufficient to perform the task;
based on the definition and the first determination, selecting, from the plurality of sensor modalities, a second sensor modality having a second operational cost, wherein the second operational cost is higher than the first operational cost;
responsive to selecting the second sensor modality, capturing a second sensor signal using the second sensor modality;
based on the second sensor signal, making a second determination that the second sensor signal may be used to perform the task; and
responsive to the second determination, using the second sensor signal to perform the task.

2. The method of claim 1, wherein the second determination comprises determining that the second sensor signal may be used to perform the task when combined with the first sensor signal, the method further comprising performing the task using the first sensor signal in combination with the second sensor signal.

3. The method of claim 2, further comprising:
based on the first determination, storing the first sensor signal in a storage; and
based on the second determination, retrieving the first sensor signal from the storage.

4. The method of claim 1, wherein the second determination comprises determining that the first sensor signal is not necessary to perform the task while the second sensor signal is available, the method further comprising:
based on the first determination, storing the first sensor signal in a storage; and
based on the second determination, discarding the first sensor signal from the storage.

5. The method of claim 1, further comprising:
based on the definition and the first determination, selecting, from the plurality of sensor modalities, a third sensor modality having a third operational cost, wherein the third operational cost is lower than the second operational cost and is higher than the first operational cost;
responsive to selecting the third sensor modality, capturing a third sensor signal using the third sensor modality; and
based on the first sensor signal and the third sensor signal, making a third determination that the third sensor signal is not sufficient to perform the task,
wherein selecting the second sensor modality is further based on the third determination.

6. The method of claim 5, wherein a combined signal comprises the first sensor signal and the third sensor signal, and the third determination further comprises determining that the combined signal is not sufficient to perform the task.

7. The method of claim 1, further comprising:
ordering the plurality of sensor modalities according to their respective operational costs,
wherein selecting the first sensor modality comprises selecting a signal modality with a lowest operational cost.

8. The method of claim 1, wherein each operational cost comprises one or more of an energy usage cost, an energy efficiency cost, or a computational cost.

9. The method of claim 1, wherein the plurality of sensor modalities comprise an inertial measurement unit (IMU) modality, an audio modality, an image modality, and a video modality.

10. A non-transitory non-volatile computer-readable medium storing a program for signal processing, which when executed by a computer, configures the computer to:
receive a definition associated with a task;
based on the definition, select from a plurality of sensor modalities each associated with respective operational costs, a first sensor modality having a first operational cost;
responsive to selecting the first sensor modality, capture a first sensor signal using the first sensor modality;
based on the first sensor signal, make a first determination that the first sensor signal is not sufficient to perform the task;
based on the definition and the first determination, select, from the plurality of sensor modalities, a second sensor modality having a second operational cost, wherein the second operational cost is higher than the first operational cost;
responsive to selecting the second sensor modality, capture a second sensor signal using the second sensor modality;
based on the second sensor signal, make a second determination that the second sensor signal may be used to perform the task; and
responsive to the second determination, use the second sensor signal to perform the task.

11. The non-transitory non-volatile computer-readable medium of claim 10, wherein the second determination comprises determining that the second sensor signal may be used to perform the task when combined with the first sensor signal, and the program, when executed by the computer, further configures the computer to:
perform the task using the first sensor signal in combination with the second sensor signal;
based on the first determination, store the first sensor signal in a storage; and
based on the second determination, retrieve the first sensor signal from the storage.

12. The non-transitory non-volatile computer-readable medium of claim 10, wherein the second determination comprises determining that the first sensor signal is not necessary to perform the task while the second sensor signal is available, and the program, when executed by the computer, further configures the computer to:
based on the first determination, store the first sensor signal in a storage; and
based on the second determination, discard the first sensor signal from the storage.

13. The non-transitory non-volatile computer-readable medium of claim 10, wherein the program, when executed by the computer, further configures the computer to:
based on the definition and the first determination, select, from the plurality of sensor modalities, a third sensor modality having a third operational cost, wherein the third operational cost is lower than the second operational cost and is higher than the first operational cost;
responsive to selecting the third sensor modality, capture a third sensor signal using the third sensor modality; and
based on the first sensor signal and the third sensor signal, make a third determination that the third sensor signal is not sufficient to perform the task,
wherein selecting the second sensor modality is further based on the third determination.

14. The non-transitory non-volatile computer-readable medium of claim 13, wherein a combined signal comprises the first sensor signal and the third sensor signal, and the third determination further comprises determining that the combined signal is not sufficient to perform the task.

15. The non-transitory non-volatile computer-readable medium of claim 10, wherein each operational cost comprises one or more of an energy usage cost, an energy efficiency cost, or a computational cost.

16. The non-transitory non-volatile computer-readable medium of claim 10, wherein the plurality of sensor modalities comprise an inertial measurement unit (IMU) modality, an audio modality, an image modality, and a video modality.

17. A system for signal processing, comprising:
a processor;
a plurality of sensor modalities each associated with respective operational costs; and
a non-transitory non-volatile computer readable medium storing a set of instructions, which when executed by the processor, configure the system to:
receive a definition associated with a task;
based on the definition, select from the plurality of sensor modalities a first sensor modality having a first operational cost;
responsive to selecting the first sensor modality, capture a first sensor signal using the first sensor modality;
based on the first sensor signal, make a first determination that the first sensor signal is not sufficient to perform the task;
based on the definition and the first determination, select, from the plurality of sensor modalities, a second sensor modality having a second operational cost, wherein the second operational cost is higher than the first operational cost;
responsive to selecting the second sensor modality, capture a second sensor signal using the second sensor modality;
based on the second sensor signal, make a second determination that the second sensor signal may be used to perform the task; and
responsive to the second determination, use the second sensor signal to perform the task.

18. The system of claim 17, wherein the second determination comprises determining that the second sensor signal may be used to perform the task when combined with the first sensor signal, and the instructions, when executed by the processor, further configure the system to:
perform the task using the first sensor signal in combination with the second sensor signal;
based on the first determination, store the first sensor signal in a storage; and
based on the second determination, retrieve the first sensor signal from the storage.

19. The system of claim 17, wherein the second determination comprises determining that the first sensor signal is not necessary to perform the task while the second sensor signal is available, and the instructions, when executed by the processor, further configure the system to:
based on the first determination, store the first sensor signal in a storage; and
based on the second determination, discard the first sensor signal from the storage.

20. The system of claim 17, wherein the instructions, when executed by the processor, further configure the system to:
based on the definition and the first determination, select, from the plurality of sensor modalities, a third sensor modality having a third operational cost, wherein the third operational cost is lower than the second operational cost and is higher than the first operational cost;
responsive to selecting the third sensor modality, capture a third sensor signal using the third sensor modality; and
based on the first sensor signal and the third sensor signal, make a third determination that the third sensor signal is not sufficient to perform the task,
wherein selecting the second sensor modality is further based on the third determination.
